(19) United States
(12) Patent Application Publication
(10) Pub. No.: US 2004/0230653 A1
(43) Pub. Date: Nov. 18, 2004

(54) Structure for an electronic newsletter subscription system of a multimedia messaging service

(76) Inventors: Sheng-Hsuan Liao, Taipei (TW); Meng-Ying Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/820,731

(22) Filed: Apr. 9, 2004

(30) Foreign Application Priority Data
Apr. 11, 2003 (TW) 092108439

(51) Int. Cl. G06F 15/16

(52) U.S. Cl. 709/204; 709/228

(57) ABSTRACT

A structure of an electronic newsletter subscription system for multimedia messaging services is disclosed. A subscriber can use different tools to access a portal to view different kinds of electronic newsletters, and then subscribe to various electronic newsletters. When it's time to send the newsletters, according to the set time a push portal contacts the message service provider where newsletters are stored to obtain the data for the desired newsletters and the subscriber list. Then the newsletter obtained by the push portal is sent by a common service platform to a multimedia messaging service center according to the subscriber list. Finally, the multimedia messaging service center sends the newsletters to the subscriber's mobile phones.

### BACKGROUND OF THE INVENTION

1. Field of the Invention

The present invention relates to multimedia messaging services. More specifically, the present invention discloses a structure for a newsletter subscription system of a multimedia messaging service, whereby subscribers can use unstructured supplementary service data (USSD) protocol or wireless application protocol (WAP) via mobile phones or access the Internet via a computer, to subscribe to newsletters in order to allow users to receive newsletters on mobile phones which have multimedia messaging service receiving functions.

2. Description of the Prior Art

Due to the fast development and growth of Short Messaging Service (SMS), people's lifestyles have changed, such as in their work, leisure and entertainment. People can use SMS to receive and download text messages to their mobile phones, in order to obtain the latest information, like stock market info or news. However, SMS only offers transmitting or downloading text messages. Additionally, the capacity of each message is only 69 Chinese characters or 159. English letters. Furthermore, it does not allow transmitting or downloading images or animations. These inconveniences are just some of the disadvantages of the current message service.

Today, people can manage images, text and audio on 3^{rd} generation (3G) mobile phones by using multimedia messaging services (MMS). That is to say, people can use MMS on their mobile phones to send and receive images and movie clips, so that the disadvantages mentioned above can be overcome.

However, utilization of advanced services, such as subscription and delivery services has yet to be implemented. Therefore, there is need delivery system that is easy to maintain and access.

### SUMMARY OF THE INVENTION

To achieve these and other advantages and in order to overcome the disadvantages of the conventional method in accordance with the purpose of the invention as embodied and broadly described herein, the present invention provides a structure for a newsletter subscription system of a multimedia messaging service, whereby subscribers can use unstructured supplementary service data (USSD) protocol or wireless application protocol (WAP) via mobile phones or access the Internet via a computer, to subscribe to newsletters in order to allow users to receive newsletters on mobile phones which have multimedia messaging service receiving functions.

An objective of the present invention is to provide a structure for a newsletter subscription system of a multimedia messaging service, so that mobile phone users can subscribe to newsletters through different tools, and can receive newsletters directly on mobile phones that can receive MMS. In this way, the added value of mobile phones is enhanced and user satisfaction is increased.

Another object of the present invention is to provide a structure for a newsletter subscription system of a multimedia messaging service, so that the transmission flow and distribution of the newsletters can be easily controlled. Under this structure new newsletters can be added rapidly, in order to enrich the content of the service.

The present invention comprises a subscription portal, which allows users to check the various kinds of newsletters available in order to subscribe to the ones of their choice. Meanwhile, users can also check the kinds of newsletters they have subscribed to previously. Subscribers can use USSD or WAP via a mobile phone, or use a computer to access the Internet or Web in order to enter the subscription portal, so that subscribers can check their list of subscribed newsletters. The service provider stores the contents of the newsletters and can also receive subscriptions from subscribers.

When it is the time to transmit newsletters, a push portal contacts the service provider to obtain the contents of the newsletters and a list of subscribers according to the time of subscription or newsletter delivery time. Then, the push portal sends the obtained newsletters to a common service platform according to the list of subscribers. The common service platform transfers the received messages to a multimedia messaging service center. Finally, the MMS center sends the newsletter contents to the subscriber's mobile phones.

In this way, the present invention for an MMS electronic newsletter subscription system provides an easily-maintainable structure of managing, distributing.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a structure for a newsletter subscription system of a multimedia messaging service, according to an embodiment of the present invention; and

FIG. 2 is a block diagram illustrating a structure for a newsletter subscription system of a multimedia messaging service, according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention provides a structure for a newsletter subscription system of a multimedia messaging service, so that mobile phone users can subscribe to newsletters through different means, and can receive newsletters directly on mobile phones that can receive MMS. In this way, the added value of mobile phones is enhanced and user satisfaction is increased.

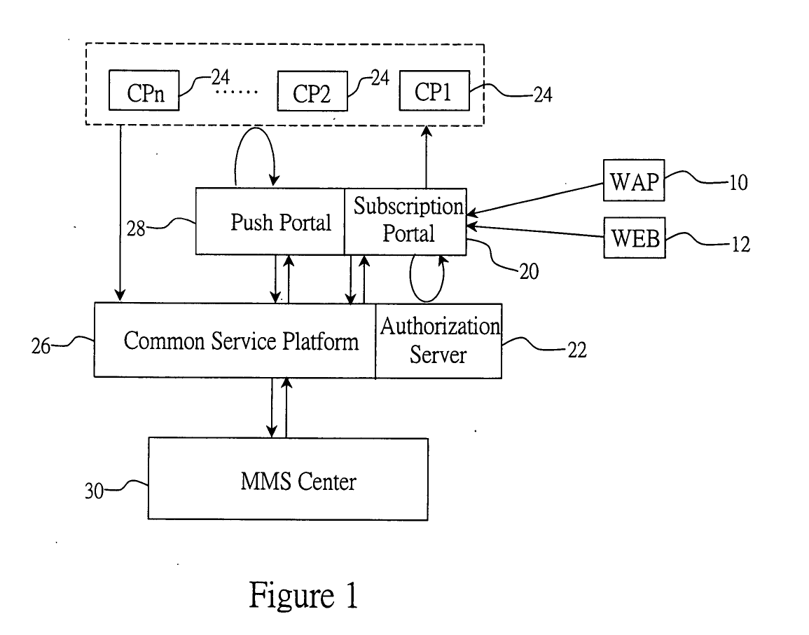

Refer to FIG. 1, which is a block diagram illustrating a structure for a newsletter subscription system of a multimedia messaging service, according to an embodiment of the present invention.

As shown in FIG. 1, mobile phone users can use WAP 10 via a mobile phone or the Web 12 via a computer to enter the subscription portal 20. The subscription portal 20 comprises a list of multimedia electronic newsletters to which subscribers can subscribe. When a subscriber enters the subscription portal 20, the subscriber goes to or is directed to the authorization server 22 to login, in order to utilize the subscription service. After logging in, users can select from a list of different kinds of newsletters available on the subscription portal 20. These multimedia electronic newsletters are stored at the plurality of multimedia information service content providers 24 (CP1-CPn). The format of the files is typically a compressed format, for example ZIP format. Additional new content can be easily and quickly added, in order to enrich the variety of the service.

After the subscriber has selected a type of newsletter, the subscription portal 20 switches the subscription mode to the information content provider 24 of the selected type of newsletter, in order to subscribe to the newsletter. The information content provider 24 is usually located at a remote location away from the rest of the system. The subscription portal 20 connects to the website of the content provider 24 according to the kind of newsletter subscribed to. In doing so, subscribers can subscribe to different kinds of newsletters through the subscription portal 20 only and don't need to go to each independent website in order to subscribe to the newsletters. Therefore, the convenience of subscribing is enhanced.

When subscribing to newsletters, the delivery time can also be chosen, if the information provider supports this function for the subscribers to choose. When the subscriber completes the subscription information, the information content provider 24 sends the chosen newsletter info selected by the subscriber, to a common service platform 26. Each time the subscriber needs to pass an authorization server 22 to complete a login procedure, after which the subscription portal 20 sends a request to the common service platform 26. When the subscriber enters the authorization server 22 and completes login, the subscription portal 20 sends a request to the common service platform 26; so that the previous electronic newsletters subscription details are sent to the subscription portal 20 and are displayed. In this way, the subscriber is able to view all the details of his subscriptions.

When it is time to send the electronic newsletters, a push portal 28 enters the message content provider 24 and obtains the content of the newsletters and a list of subscribers according to the delivery time. The push portal 28 sends the obtained newsletters to a common service platform 26 according to the list of subscribers. After the common service platform 26 receives the message from the push portal 28, it sends a reply or acknowledgement to the push portal 28. Then, after the MMS center 30 receives the message from the common service platform 26, it sends a reply or acknowledgement to the common service platform 26. Finally, the MMS center 30 sends the electronic newsletters to the subscriber's mobile phones to complete the operation.

Additionally, the push portal 28 can control the transmission flow of electronic newsletters. For example, the push portal 28 can be set up to only have one transmission channel for transmitting the electronic newsletter data at a time and each transmission channel only has one setting to send the newsletter to the subscriber. For example, settings could be made so that there are only 5 transmission channels to send newsletters to subscribers at a time, and each transmission channel can send newsletters to 10 subscribers. These settings can be modified according to the situation.

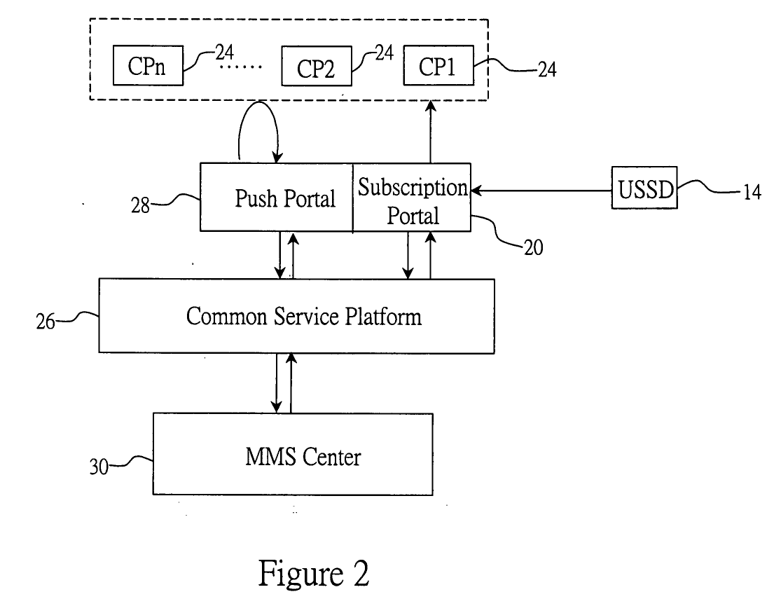

Refer to FIG. 2, which is a block diagram illustrating a structure for a newsletter subscription system of a multimedia messaging service, according to an embodiment of the present invention.

As shown in FIG. 2, subscribers can use USSD 14 via a mobile phone to access the subscription portal 20 with a digital input. The subscription portal 20 displays multiple electronic newsletters so that newsletters can be subscribed to digitally. For example, when a selected newsletter is to be delivered at a certain time, the code of the desired newsletter is input along with the delivery time. Once the subscriber completes the subscription, the subscription portal 20 sends the subscription information to the message content provider 24 of the subscribed newsletter. At the same time, it also sends the selected newsletter data to the common service platform 26. The subscription portal 20 sends a request or demand to the common service platform 26 in order to obtain the details of the electronic newsletter subscription. The data will then be displayed for reference on the subscription portal 20, when a subscriber enters the subscription portal 20. The subsequent operation of newsletter transmission is the same as previously described.

The structure for a newsletter subscription system of a multimedia messaging service according to an embodiment of the present invention allows mobile phone users to use WAP 10, Web 12, or USSD 14 to enter the subscription portal 20 in order to subscribe to electronic newsletters. In doing so, subscribers can use different tools to subscribe to electronic newsletters using a push portal 28 through a common service platform 26 and an MMS center 30 sends the electronic newsletters to the mobile phone of the subscriber. The present invention facilitates the reception of electronic newsletters for subscribers, and enhances the added value of multimedia messaging for mobile phones. It also allows users to receive electronic newsletters with electronic equipment other than computers, in order to increase mobility since it allows subscribers to receive the latest news anywhere. Additionally, using a push portal 28 to send the electronic newsletters controls the flow of transmission and enhances efficiency. The prepared data of the message content provider unit 24 (CP1-CPn) is typically compressed, for example in ZIP file format, in order to shorten the transmission time. The message content provider 24 can update the content of the electronic newsletters rapidly, in order to provide the latest information to the subscribers for a better service.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A structure for a newsletter subscription system of a multimedia messaging service, comprising:
a subscription portal for displaying a list of available electronic newsletters;
a multimedia information content provider for storing content of the electronic newsletters and accepting subscriptions;
a push portal for obtaining the content of the electronic newsletters and a list of subscribers according to delivery time and sending the electronic newsletters according to the list of subscribers;
a common service platform for receiving data from the push portal; and
a multimedia messaging service center for receiving data from the common service platform and sending the content of the electronic newsletters to the subscriber's mobile phone.

2. The structure for a newsletter subscription system of a multimedia messaging service of claim 1, whereby the subscription portal allows subscribers to use wireless application protocol (WAP) via a mobile phone, to enter, and then to proceed with subscribing.

3. The structure for a newsletter subscription system of a multimedia messaging service of claim 1, whereby the subscription portal allows subscribers to use world wide web via a computer to enter, and then to proceed with subscribing.

4. The structure for a newsletter subscription system of a multimedia messaging service of claim 1, whereby, before the subscriber enters the subscription portal, the subscriber needs to log in through an authorization server.

5. The structure for a newsletter subscription system of a multimedia messaging service of claim 4, whereby, once the subscriber has completed log in and finished subscribing, the content provider sends data regarding the electronic newsletters selected by the subscriber to the common service platform so that when the subscriber finishes logging in, the subscription portal requests the common service platform to transmit details regarding previously subscribed newsletters and the details are displayed on the subscription portal unit.

6. The structure for a newsletter subscription system of a multimedia messaging service of claim 1, further comprising:
whereby the subscription portal allows subscribers to use unstructured supplementary service data protocol (USSD) via mobile phones to enter, and then to subscribe to electronic newsletters;
whereby, an electronic newsletter code is displayed on the subscription portal in order for the subscriber to subscribe to an electronic newsletter; and
whereby, once the subscription is completed the subscription portal transmits the selected electronic newsletters.

7. The structure for a newsletter subscription system of a multimedia messaging service of claim 6, whereby, after completing the subscription, the subscription portal sends the electronic newsletters data to the common service platform so that when the subscriber enters the subscription portal a next time, the subscription portal requests the common service platform to provide previous subscriber data and display the data on the subscription portal.

8. The structure for a newsletter subscription system of a multimedia messaging service of claim 1, whereby, the push portal controls transmission flow of the electronic newsletters; and
whereby, the push portal only has one setting as a transmission channel to transmit the content of the electronic newsletters and each transmission channel only transmits to one subscriber.

9. The structure for a newsletter subscription system of a multimedia messaging service of claim 1, whereby, after the common service platform receives the data from the push portal, the common service platform sends a reply back to the push portal.

10. The structure for a newsletter subscription system of a multimedia messaging service of claim 1, whereby the multimedia messaging service center sends a reply back to the common service platform after receiving data from the common service platform.

11. The structure for a newsletter subscription system of a multimedia messaging service of claim 1, whereby, content of the electronic newsletters on the content provider is compressed.

12. The structure for a newsletter subscription system of a multimedia messaging service of claim 11, whereby the compressed content is in ZIP file format.

13. The structure for a newsletter subscription system of a multimedia messaging service of claim 1, whereby, the content provider is located remotely.
